(19) United States
(12) Patent Application Publication
(10) Pub. No.: US 2019/0097992 A1
(43) Pub. Date: Mar. 28, 2019

(54) System and methods for minimizing security key exposure using dynamically administered bounds to cloud access

(71) Applicant: Ramesh VelurEunni, Fremont, CA (US)

(72) Inventor: Ramesh VelurEunni, Fremont, CA (US)

(73) Assignee: Ramesh VelurEunni, Fremont, CA (US)

(21) Appl. No.: 15/719,526

(22) Filed: Sep. 28, 2017

(51) Int. Cl. H04L 29/06

(52) U.S. Cl. CPC H04L 63/083; H04L 63/0853; H04L 63/06

(57) ABSTRACT

Provisioned Capacity Access Broker (PCAB) intercepts each access from every user to the cloud vendor and checks if this access credential is generated by the system. Once the software system determines, that the access credential has been generated within the system, PCAB also checks the access resources usage. Access is allowed if the cumulative resource demand is within the granted limits per the information. Successful access causes the PCAB the system with the revised cumulative resource consumption by the user. After performing these checks, it strips the user's credentials such and substitutes them with the cloud vendor's credentials for the organization and if the access involves creating or deleting an IT resource, the metadata information about the new resource is created in the system before relaying the request to the cloud vendor.

### CROSS-REFERENCE TO RELATED APPLICATIONS

This application claims the benefit of U.S. Provisional Patent Application No. 62/401,763 filed Sep. 29, 2016, entitled “System and methods for minimizing security key exposure using dynamically administered bounds to cloud access”, which is incorporated herein by reference in its entirety.

### BACKGROUND

Cloud Services widen the chance of security breaches for enterprises. IT users need security credentials to access public cloud. Sharing the root or all-you-can-eat access credentials with all IT users is fraught with security risks. IT organizations need to scale usage to many IT users or teams causing proliferation of specific credentials handed out to each user. These user credentials may be generated by Identify and Access Management software. However, users outside the organization may use any of these leaked credentials to access the organization's IT resources.

Cloud Services created a governance problem in IT organizations for cost control among teams. Each team or team member is allowed to spend practically unlimited resources without having a real budget ceiling. Forgetting to shutdown servers in the cloud, disable storage volumes or to effectively turn off a cloud service can result in millions of dollars of wasted spending for an organization.

### BRIEF DESCRIPTION OF THE DRAWINGS

FIG. 1 shows the component diagram for all the key elements for the software system.

FIG. 2 shows the hierarchy for the UserProj objects.

FIG. 3 shows the flow chart for client application interaction with the software system and the software system interaction with the cloud services.

FIG. 4 shows the 3 different types of deployment for the software system.

### SUMMARY

Provisioned Capacity Access Broker (PCAB) intercepts each access from every user and checks if this access credential is generated by the system. Private Cloud Access and Orchestration (CAO) application programming interface (API) that mimics the cloud vendor system API to the software applications. If the access credential is not generated by the software system, the PCAB stops from proceeding further and returns an error message. Once the software system determines, that the access credential has been generated within the system, PCAB also checks the access resources usage. Access is allowed if the cumulative resource demand is within the granted limits per the information maintained in user control metadata (UCMD). If granted limit is not defined for the user, the software system looks up his or her supervisor for this information. Successful access causes the PCAB to update UCMD with the revised cumulative resource consumption by the user. After performing these checks, PCAB does two tasks 1) it strips the user's credentials such and substitutes them with the cloud vendor's credentials such as Cloud Key administered initially for the organization and 2) if the access involves creating or deleting an IT resource, the metadata information about the new resource is created in UCMD before relaying the request over to the cloud vendor.

### DETAILED DESCRIPTION

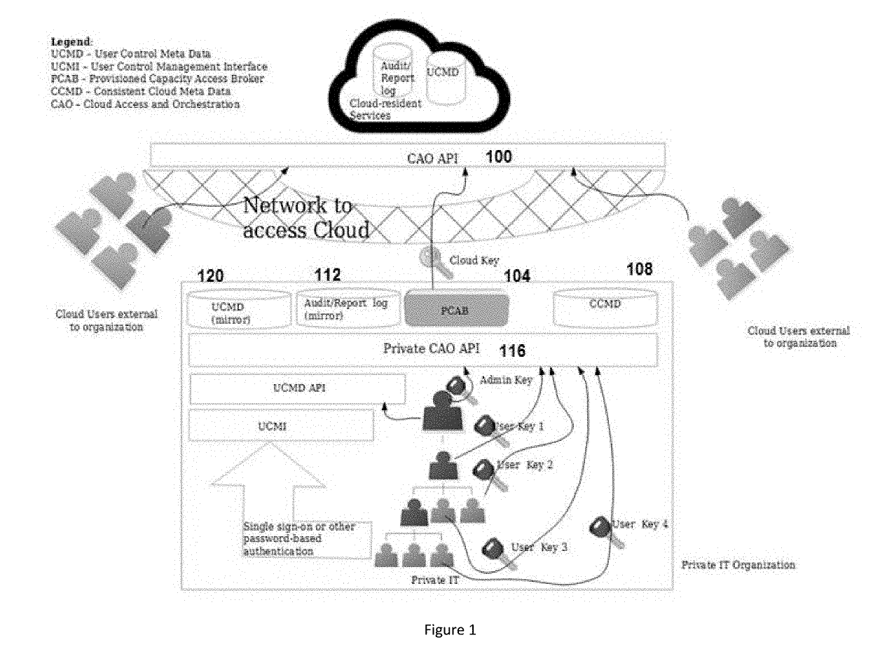

The software system is composed of the following modules: Cloud access and orchestration (CAO) module 100, provisioned capacity access broker PCAB module 104, user control metadata (UCMD) 120, consistent cloud metadata (CCMD) 108 and Audit/Report Log 112. FIG. 1 shows the component diagram for all the key elements for the software system.

CAO (Cloud Access and Orchestration) API 100 is the representation state transfer (REST) based API published by a cloud vendor so applications can be built to orchestrate or access the services. In the case of storage services, the applications can store data in the cloud using the API.

PCAB (Provisioned Capacity Access Broker) 104 is the core engine in the architecture. It exposes a Private CAO API 116 that mimics the CAO API to the applications inside an IT organization. Hence the applications are mostly oblivious to the presence of private layer of CAO API 116. PCAB 104 intercepts CAO API requests from applications to track and monitor cloud resource usage for each user and team.

UCMD (User Control Meta Data) 120 contains both the real time current usage and the real time granted usage for each user. Both the usage metrics are kept for every desired paid service from the cloud vendor for every user in the system. For example, a GB/month metric is kept for Object Storage (or disk storage) in the cloud. Similarly, Number of Hours per server type is kept as a metric for spinning servers in the cloud.

PCAB additionally exposes UCMD API in addition to private CAO API. UCMD API is built on top of the storage services of the private CAO API. Unlike regular CAO storage services, UCMD API instructs PCAB to store a copy of the data stored in UCMD in addition to storing it in the cloud (source of truth). UCMI is built using UCMD API. However, an Admin may choose to write their own applications or extend UCMI by making use of the UCMD API directly. UCMD API is not available to regular users.

CCMD (Consistent Cloud Meta Data) is meta data that is maintained by PCAB for quick and consistent access to the cloud. For example, a reference to the recently created bucket or container is kept in CCMD when the cloud storage is not strongly consistent with storing this information. It also enables the users to get metadata information quickly without having to get it from the cloud vendor. CCMD helps address the “CAP theorem” of Distributed Computing differently from what your cloud vendor may have chosen to handle. In other words, it allows the IT organization to develop client-centric strong consistency by adding a wrapper over an eventually consistent cloud storage system. While the software system is not be as highly available as a massively and geographically distributed cloud storage system, it compromises on the availability aspect by maintaining strong consistency. When the software system is not available, the architecture falls back to the eventually consistent cloud storage.

UCMI (User Control Management Interface) 120 is a uniform management dashboard for all users. It presents the same type of information but the actual information will be different for different users. UCMI is used to request or grant provisioning of resources by users and supervisors. UCMI is accessed via a single sign-on or other alternate internal authentication mechanism valid within an IT organization.

Audit/Report Log 112 is maintained in the cloud and mirrored in the software system. It contains the source IP address, MAC address and other discoverable information along with a summary of the API request (CAO or UCMD). Audit data is useful for post-mortem analysis. This can be used for any post-mortem analysis. Historical reports for each individual and/or projects or teams are maintained. Report Log is useful for historical charts and trends that drive the decisions to better estimate the future usage.

For each user in the software platform, the UserProj object (which is shown below) is created to store the username and corresponding data associated with the user who is on a specific project. The secretKey is generated by the UCMI module within the software system and provided to the user to be included in the client application. The format and the placement of the secretKey is identical to what would have obtained directly from the cloud vendor such as the secretKey component of the cloudKey. The user has a list of storage repository the user has access to. The user also has a list of instances, he or she has access to. allowedStorageCapacity provides how much storage has been allowed for the user and currentStorageCapacity is how much the user is currently using in the system. allowedInstances contains how many instance hours the user can use on the cloud server and currentInstances contain how many instance hours the user has used on the cloud server. Depending on the set of services the cloud vendor charges for, more attributes are added to the software system. Each type of service (say Storage) may have different attributes that are charged by the cloud vendor. For example, the number of Storage PUTs/GETs may be charged for. Hence a pair of attributes is added for “number of Storage PUTs/GETs” namely, allowedNumberOfPUTSGETS and currentNumberOfPUTSGETS. Similarly, if a cloud vendor offers DataBase services and charges for DataBase access by Number of Database Write Units and Read Unit, a pair of attributes is added for each of Read Unit and Write Unit respectively. For example, allowedDatabaseWriteUnits and currentDatabaseWriteUnits are added.

### UserProj

MyStorageBuckets: List of Bucket

MyInstances: List of Instance

String secretKey

String pathPrefix

String username //could come from intranet's single signon

String projectName

String supervisor

Long Integer allowedStorageCapacity

Long Integer currentStorageCapacity

Long Integer allowedInstances

Long Integer currentInstances

//More attributes to follow such as allowed and current attributes for other cloud

//Services that carry a price

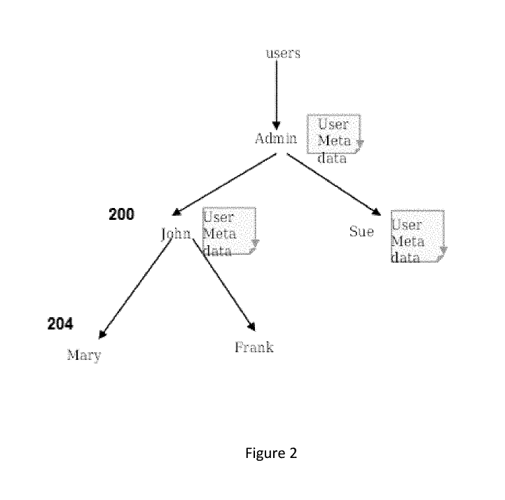

Below is an example data for stored in the UserProj objects. FIG. 2 shows the hierarchy for the UserProj objects. For example, the John (“Object 2”) 200 object has a project name of “MoveWebSErversToCloud” and identifier of “users/Admin/Metafile” with allowedInstances amount of 500,000 instance hours per month with currentInstances amount of 490,000 instance-hours per month being used. Also, the “Object 2” has the allowedStorage of 500 TB per month with the current Storage use of 400 TB per month. The Mary (“Object 4”) 204 is a child of John object 200 and uses John's grant limits and does not have its own grant limits and current usage.

### Object 1:

Identifier: users/Admin/metafile

User Meta Data:

ProjectName: “CIO”

allowedInstances: 1000,000 Instance-Hours per month

currentInstances: 129,400 Instance-Hours

allowedStorage: 1000 TB per month

currentStorage: 700 TB per month

### Object 2:

Identifier: users/Admin/John/metafile

User Meta Data:

ProjectName: “MoveWebServersToCloud”

AllowedInstances: 500,000 Instance-Hours per month

CurrentInstances: 490,000 Instance-Hours per month

allowedStorageCapacity: 500 TB

currentStorageCapacity: 400 TB

### Object 3:

Identifier: users/Admin/Sue/metafile

User Meta Data:

ProjectName: “New Concept”

allowdInstances: 500,000 Instance-Hours per month

currentInstances: 100,000 Instance-Hours per month

allowedStorageCapacity: 500 TB

currentStorageCapacity: 10 TB

### Object 4:

Identifier: users/Admin/John/Mary/metafile

### Object 5:

Identifier: users/Admin/John/Frank/metafile

### Private Key to Public Cloud Work Flow

Admin user account is created automatically when UCMI is started for the very first time. A default key is also generated for the Admin user to access the CAO API. The software system allows for regeneration of the admin key for use of the CAO API.

Admin obtains a set of credentials (Cloud Key) from the cloud vendor. Cloud key is required in order to get access to the cloud resources. The credentials are stored in a secure location that has access only to the Admin or his or her designates. Admin chooses a suitable Cloud Key for all cloud access from the organization and administers the Cloud Key in PCAB via UCMI. This Cloud Key is needed to access the cloud vendor's services; thus, every time, there is an access to the cloud vendor's services, Cloud Key is used.

Admin creates a project for the organization and assigns an owner using the UCMI. The owner is looked up through the single-sign on or any alternate internal authentication mechanism implemented in the organization. Admin creates a unique private access credential such as “User Key 1” via UCMI for the project owner to access the cloud. The access credential (e.g., “User Key 1”) is not valid on the public internet. Access credential format from a cloud vendor typically allows for a key component followed by a secret component. The key component of private access credential contains the supervisory path to the user on a project. The supervisory path is a string that contains the chain of supervisors including the user in question. The chain is delimited with ‘/’ character in the string. The secret component of private access credential is randomly generated by UCMI. This way, the private access credential looks and behaves like the CloudKey that the user's cloud application would otherwise use to access cloud services directly.

Project owner has his or her own account into UCMI. After signing into the account, Project owner may assume the role of a Project lead and add other direct team members under them using UCMI on behalf of a new or existing project. Project owner may optionally divide the project into sub projects and assign owners for each of the sub projects. This is done via UCMI in the same way Admin created a project in the first place, however, without involving Admin. UCMD maintains the hierarchical structure of projects/users thus created. For some IT organizations, this may as well mimic the employee reporting structure. For IT organizations that are more dynamic in their employee reporting structure such as agile teams, UCMI mimics the structure of the dynamic teams. In this case, this does not require integration with the employee reporting structure maintained by the Human Resources department. Below shows the PCAB HTTP PUT processing pseudo code capturing the metric values.

user = users[Request.accessKey] // accessKey = AWSKey in AWS
example
From HTTP Request, find <size> of data // applicable to Storage service
While (user)

If user.Allowed<Metric> == ZERO_BUDGET

user = User.Supervisor
Continue While Loop

If (user.Current<Metric> +size) < user.Allowed<Metric>

user.Current<Metric> += user.Allowed<Metric>
Update UCMDMirror [user.fullOrganizationPath] = user
/* Cloud source of truth */
Update UCMD [user.fullOrganizationPath] = user
If storage service, update Object identifier as

Object identifier: user.fullOrganizationPath

HTTP PUT the received request to Cloud website using
CloudKey

Else
Standard HTTP Error
/* After this, user requests additional resources via UCMI */

Any user in the UCMD hierarchy may make capacity requests by signing into their own UCMI account. Capacity requests for cloud resources are needed in order for the user to perform his work. For example, a user may request 100 instance hours of work and 100 GB of data to store in the cloud. The immediate or higher supervisor of the user as per the hierarchy may grant or decline the capacity request by signing into their UCMI account. Once granted, the newly provisioned capacity is in effect. Capacity request and grant notifications via email and/or mobile text messages are built into UCMI.

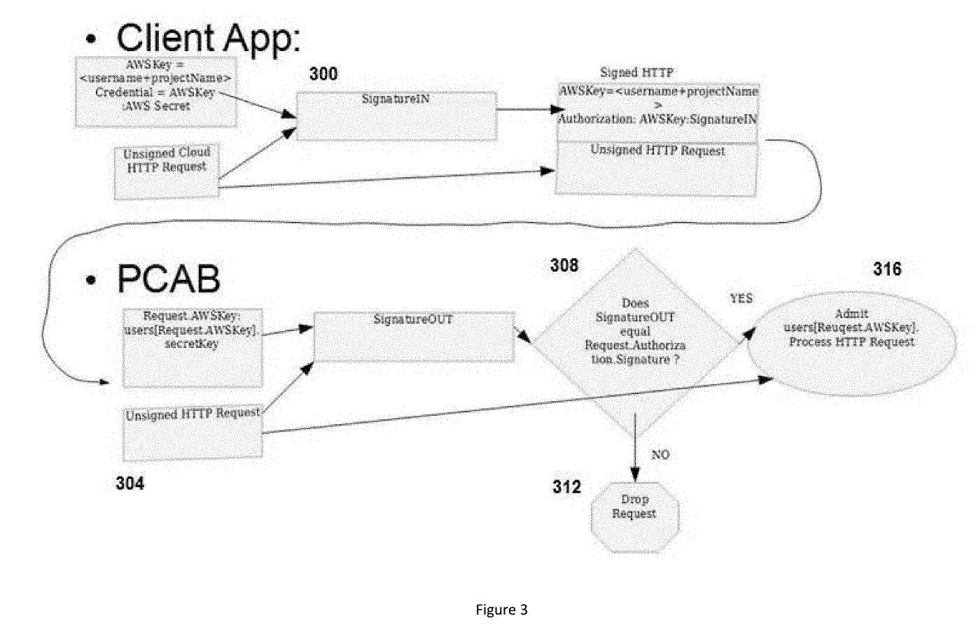

FIG. 3 shows the flow chart for the client application use of the software system and how the software system in turns connects to the cloud services. User's application 300 uses the unique access credential such as User Key 4 for the user to access Cloud Services. This is usually done by updating the configuration file from where user's application picks up the configured credentials. In addition, user's application may need to be modified to point the target address to PCAB's hostname or IP address instead of the cloud vendor's hostname or address. On the other hand, a transparent proxy may be implemented in PCAB in order to avoid having to modify user applications to point a PCAB's hostname or IP address.

PCAB intercepts each access 304 from every user and checks if this access credential is generated by the system 308. If the access credential is not generated by the software system, the PCAB stops from proceeding further and returns an error message 312. Once the software system determines, that the access credential has been generated within the system 316, PCAB also checks the access resources usage. Access is allowed if the cumulative resource demand is within the granted limits per the information maintained in UCMD. If granted limit is not defined for the user, the software system looks up his or her supervisor for this information. Successful access causes the PCAB to update UCMD with the revised cumulative resource consumption by the user. After performing these checks, PCAB does two tasks 1) it strips the user's credentials such as User Key 4 and substitutes them with the cloud vendor's credentials such as Cloud Key administered initially for the organization and 2) if the access involves creating or deleting an IT resource, the metadata information about the new resource is created in UCMD before relaying the request over to the cloud vendor. This metadata information is maintained under the user hierarchy in order to return accurate information back to the user for later list/query operations. An extended metadata information about the new resource is kept in CCMD in order to deliver strongly consistent data for later list/query operations. After the resource is stabilized or committed in the cloud, CCMD may clean up any non-stale information to accommodate more “in-flight” information. Depending on the level of data consistency, PCAB transforms client operations such that the data stored in the cloud is strongly consistent. For example, PCAB transforms an eventually consistent update of object data into a strongly consistent new object write. In this case, it deletes the old version of object in the cloud. The old object identifier as seen by the client application is still valid but PCAB translates the old object identifier to the newly created object identifier by maintaining a mapping in CCMD.

If cloud vendor allows tagging a resource, PCAB may tag the resource with a string that contains the chain of supervisors including the user. The supervisory path is a string that contains the chain of supervisors including the user in question. The chain is delimited with ‘/’ character in the string. In the case of cloud object storage, the PCAB prefixes the storage object identifier with a string that contains the chain of supervisors including the user. The chain is delimited with ‘/’ character in the string. These techniques allow the user to only see their resources and thus, provides enhanced security.

If the new cumulative resource demand exceeds the granted limits, the access is denied and a suitable HTTP error is returned to user's applications. For example, the cloud storage application will not be able to write any more data of the requested size or the cloud server instance orchestration application will not be able to spin any more servers in the cloud. In response to this, the user may ask for more resources from his/her supervisor using UCMI as outlined in [00020] if there is a legitimate need to consume more resources and wait for the supervisor to grant the increase.

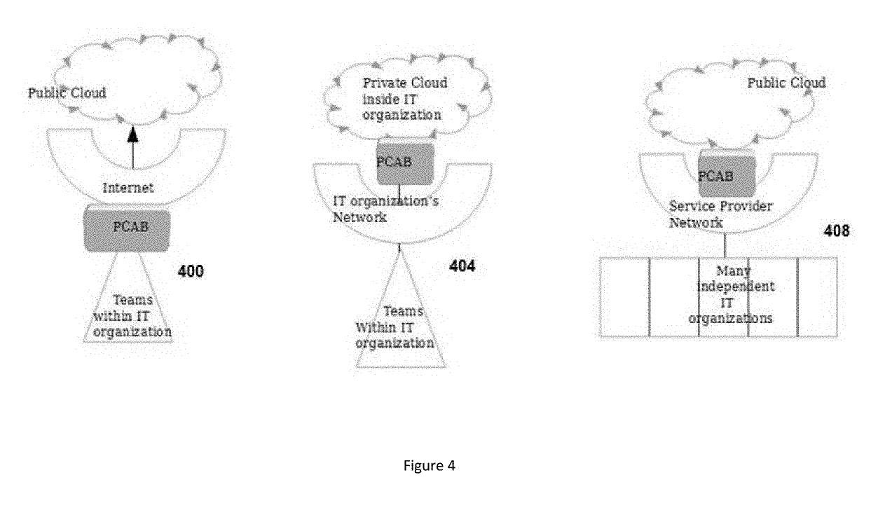

FIG. 4 shows the 3 different types of deployment for the software system. All the modules may be hosted in the cloud 400 or on premise 404. In both scenarios, IT organization's Identity and Access Management controls are separated from the cloud vendor's Identify and Access Management controls. All modules which are hosted in the cloud can be shared by multiple IT organizations 408. On premise implementations have greatest privacy and security as user credentials cannot be used by an individual that does not have connectivity to the IT organization's PCAB.

A highly available system may be constructed by creating replicas of the PCAB system. This results in faster recovery upon a single PCAB system failure. If the primary PCAB system and all of its replicas become unavailable, A new PCAB system could be brought up which will reconstruct UCMD and Audit Log from the cloud backing storage which is expected to be durable. CCMD is populated from the content in the cloud storage.

All examples and conditional language recited herein are intended for educational purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents hereof. Additionally, it is intended that such equivalents include both currently known equivalents as well as equivalents developed in the future, i.e., any elements developed that perform the same function, regardless of structure.

1. A computer implemented method to provide restricted access to cloud resources, comprising:
intercepting each access using a secret key to a system for a user and checking if an access credential is generated by a system;
if said access credential has been generated by said system, checking an access resources usage of said user;
if access is allowed for said user, calculating if the cumulative resource demand is within the granted limits for said user;
if granted limit is not defined for the user, checking user's supervisor for granted limitation;
if user is within granted limit, updating a cumulative resource consumption for said user;
striping the user's credentials and substituting them with the cloud vendor's credentials;
submitting user access to a cloud vendor; and
updating a metadata information related to a resource under the user hierarchy.

2. The computer implemented method of claim 1 wherein secret key is generated by the system and provided to the user to be included in the client application and the format and the placement of the secret key is identical to the what would have obtained directly from the cloud vendor such as the secret key component of the cloud key.

3. The computer implemented method of claim 1 wherein the secret key component of access credential contains the supervisory path to the user.

4. The computer implemented method of claim 1 wherein said user has a list of cloud computing resources has access only to what said user has created or a sub-user has created, how much cloud storage has been allowed for said user, and how many instance hours said user can use on the cloud server in a hierarchical structure of projects/users.

5. A computer system comprising of:
a cloud access and orchestration module to orchestrate or access a cloud system,
a provisioned capacity access broker module mimicking said cloud access and orchestration module and which a client system communicates with,
a user control metadata module used to real time current usage and the real time granted usage for each user,
a consistent cloud metadata module used to store system meta data that is maintained for quick and consistent access to the cloud, and
an audit/report log used to maintain the cloud and mirrored logs of the software system.

6. The computer implemented system according to claim 5 wherein said user and projects stored in user control metadata module are created in hierarchical structure.

7. A computer implemented method to provide restricted access to cloud resources, comprising:
intercepting each access using a secret key to a system for a user and checking if an access credential is generated by a system;
striping the user's credentials and substituting them with the cloud vendor's credentials wherein secret key given to a user is not valid if submitted directly to the public cloud vendor, wherein public key used to access the public cloud resource is securely kept by the administrator of the IT organization, not visible to regular users of the organization and wherein a reference to the recently created bucket or container is kept in said consistent cloud metadata when the cloud storage is not strongly consistent with storing this information;
submitting user access to a cloud vendor;
